(19) United States
(12) Patent Application Publication
(10) Pub. No.: US 2008/0162349 A1
(43) Pub. Date: Jul. 3, 2008

(54) METHOD OF COLLECTING MONEY OR RESOURCES FROM A GROUP OF CONTRIBUTORS

(76) Inventors: John Pratt, Austin, TX (US); Louis Helm, Austin, TX (US)

Correspondence Address: SCHOX PLC, 730 Florida Street #2, San Francisco, CA, 94110, US

(21) Appl. No.: 11/963,440

(22) Filed: Dec. 21, 2007

Related U.S. Application Data
(60) Provisional application No. 60/871,724, filed on Dec. 22, 2006.

(51) Int. Cl. G06Q 20/00

(52) U.S. Cl. 705/44

(57) ABSTRACT

A method of collecting money or resources from a group of contributors includes accepting a pledge from a first contributor, authorizing the pledge, and converting the authorized pledge to a payment. The pledge provides pledge information including an amount of money pledged and a method of payment. The pledge is authorized by verifying the validity of the method of payment and verifying that the method of payment is able to provide the amount of money pledged. The pledge is converted to a payment when the sum of the amounts of money pledged by the authorized pledges is greater than or equal to the predetermined amount of money. The method is preferably designed for the fundraising field and, more specifically, for the online fundraising field. The method, however, may be alternatively used in any suitable environment and for any suitable reason.

### CROSS-REFERENCE TO RELATED APPLICATIONS

This application claims the benefit of U.S. Provisional Application No. 60/871,724 filed on 22 Dec. 2006, which is incorporated in its entirety by this reference.

### TECHNICAL FIELD

This invention relates generally to the online fundraising field, and more specifically to a new and useful method of collecting money or resources from a group of contributors.

### BACKGROUND

Conventionally, in the fundraising field and more specifically in the online fundraising field, a group of people cannot rely on the commitment of the entire group when pooling money. Both fundraisers and contributors incur risk by participating in a fundraising event. The fundraiser runs the risk that any one of the contributors may not follow through with their commitment to contribute funds. For example, the fundraiser may stop fundraising under the assumption that they have raised sufficient funds, only to find out that a contributor has not followed through, and therefore, the fundraiser has failed to raise sufficient funds. Similarly, a contributor also runs the risk that any one of the other contributors may not follow through with their commitment to contribute funds. A contributor may contribute funds under the assumption that all other contributors will contribute, only to find out that another contributor has not followed through, and therefore, the fundraiser failed to raise sufficient funds and the event or purchase will not take place and the contributor has contributed to an unsuccessful fundraising event. Thus, there is a need in the online fundraising field to create new and useful method of collecting money or resources from a group of contributors that substantially reduces these risks. This invention provides such a new and useful method of collecting money or resources from a group of contributors.

### BRIEF DESCRIPTION OF THE FIGURES

FIGS. 1-3 are flowchart representations of preferred embodiments of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

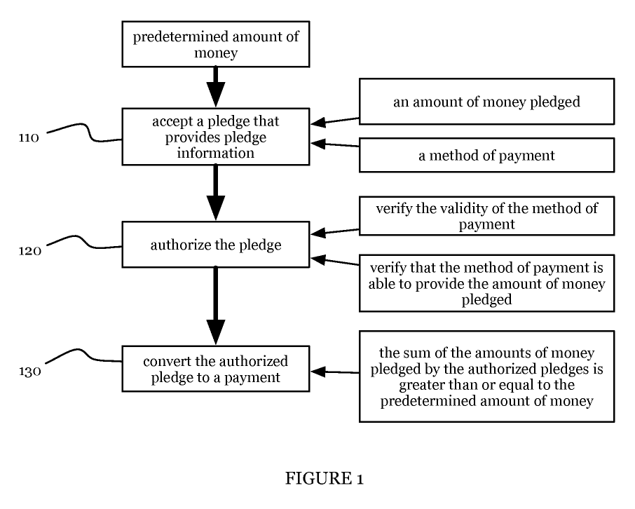

As shown in FIG. 1, a method of collecting money or resources from a group of contributors includes accepting a pledge from a first contributor S110, authorizing the pledge S120, and converting the authorized pledge to a payment S130. The pledge provides pledge information including an amount of money pledged and a method of payment. The pledge is authorized by verifying the validity of the method of payment and verifying that the method of payment is able to provide the amount of money pledged. The pledge is converted to a payment when the sum of the amounts of money pledged by the authorized pledges has reached or exceeded the predetermined amount of money. The method is preferably designed for the fundraising field and, more specifically, for the online fundraising field. The method, however, may be alternatively used in any suitable environment and for any suitable reason.

Step S110, which recites accepting a pledge from a first contributor, functions to accept pledge information including an amount of money pledged and a method of payment. A person who wishes to contribute to a fundraising event preferably submits a pledge. By submitting the pledge, the contributor preferably enters pledge information. The pledge information is preferably entered by either by manual entry of the information into the system, or the pledge information may alternatively be entered by a card imprinter, point-of-sale (POS) terminal, a virtual terminal, or any other suitable method. The pledge information preferably includes an amount of money pledged by the contributor, a method of payment that the contributor wishes to use for the eventual transaction, and any other suitable information such as their contact information and/or email address. The method of payment is preferably through a payment processing account such as PayPal or Google Checkout or a cash transfer through an online bank account or through a debit or credit card such as Visa, Mastercard, American Express, and Discover. The method of payment may alternatively be any other suitable form of payment. In Step 110, while the pledge and the pledge information is accepted by the system, no money or payment is accepted in this step. The pledge does not constitute a payment or an exchange or transfer of money or resources. The system preferably accepts pledges from at least a single contributor and more preferably from several contributors, constituting a group of more than one contributors. A contributor is preferably a single person, but may alternatively be a group of people or a company, nonprofit group, firm, or other suitable entity. The system may also accept a pledge from the fundraiser or group leader.

Step S120, which recites authorizing the pledge, functions to verify the validity of the method of payment and to verify that the method of payment is able to provide the amount of money pledged. In this step, the system initiates what is known as a “payment authorization” or an “authorization hold” for each pledge. In this step, the system preferably does not handle or store the method of payment information from the contributor, but rather uses a third party financial institution or other organization that provides card processing services, such as PayPal or Google Checkout or other banking or credit systems. Alternatively, the system may directly perform the authorization of the pledge. All amounts of money pledged are preferably in U.S. Dollars or converted to this by the third party payment processor. In this case, the amount of money pledged will preferably be based on the exchange rate in effect on the pledge date or the day the pledge is converted to a payment (see Step S130). In Step 120, while the pledge is authorized by the system, no money or payment is accepted in this step. The pledge or authorization of the pledge does not constitute a payment or an exchange or transfer of money or resources. Furthermore, preferably no fees, such as transaction fees or processing fees, are incurred by the fundraiser or the contributor in this step. The pledge and the authorization of the pledge is preferably free to the fundraiser and the contributor.

A “payment authorization” or “authorization hold” is the practice within the banking industry of authorizing electronic transactions to be completed with a debit card, credit card, or online account. Once the system accepts the pledge information from the contributor, including an amount of money pledged and a method of payment (Step S110), the system authorizes the pledge (Step S120) by verifying that the contributor's method of payment is valid and that sufficient funds are available in the specified method of payment to cover the amount of money pledged (and an additional percentage or a fixed dollar amount if necessary). Once the method of payment is authorized, the amount of money pledged (and an additional percentage or a fixed dollar amount if necessary) is preferably held as “unavailable” to the contributor, either until the system converts the pledge into a payment (Step S130), the pledge is voided (Step S140), the hold “falls off”, or any other suitable event occurs. Once the method of payment is verified, the funds are “held” but no money or payment is accepted in this step. The pledge or authorization of the pledge does not constitute a payment or an exchange or transfer of money or resources. The funds may be deducted from the customer's credit limit (or bank balance, in the case of a debit card), however, the pledge and the authorization of the pledge is preferably free to the fundraiser and the contributor.

The step of authorizing the pledge includes submitting the pledge information to an acquirer or third party financial institution or other organization that provides card processing services to the system, such as PayPal or Google Checkout. The acquirer verifies with an issuer that the method of payment (i.e. card number or account number, expiration date, card security code (CSC), card verification value or code (CVV or CVC), and/or any other suitable information) and the amount of money pledged are both valid, and then processes the pledge for the contributor. The issuer is the financial institution or other organization that issued the credit card, debit card or account to the contributor. After the pledge is authorized it is then preferably stored or recorded, which the system can later send to the acquirer to receive payment (see Step S130).

Step S130, which recites converting the authorized pledge to a payment, functions to convert the amount of money pledged to a payment via the specified method of payment when the sum of the amounts of money pledged by the authorized pledges has reached or exceeded the predetermined amount of money. As stated above, after the pledge is authorized, it is then preferably stored or recorded. When the sum of the amounts of money pledged by the stored or recorded authorized pledges has reached or exceeded the predetermined amount of money, the software then (and not before) converts the authorized pledges into real payments. This step provides the concept of “binary commitment” that reduces or eliminates risk for both the fundraiser and the contributors. “Binary commitment” is the concept that either the group participates as a whole or it does nothing, i.e. no one pays until and unless the sum of the amounts of money pledged by the stored or recorded authorized pledges has reached or exceeded the predetermined amount of money. This allows contributors to participate in a group purchase or fundraiser without worrying about what other people will do.

The predetermined amount of money is preferably greater than or equal to $200, but may alternatively be any suitable amount of money. The predetermined amount of money is preferably adjustable. In a first variation, the predetermined amount of money can be reduced within the first 5 days of the predetermined length of time, but may alternatively be adjustable in any suitable fashion in any suitable period of time.

In this step, the system preferably performs a “settlement”, where once the predetermined amount of money is reached, the system captures money from each contributor's authorized pledge. The funds (the amount of money pledged) are transferred from the contributor's accounts to the system, thus converting a pledge for an amount into an actual payment for that amount. In a first variation, converting the authorized pledge to a payment includes sending the stored or recorded authorized pledges to the acquirer or third party (such as PayPal or Google Checkout) to receive payment. For credit card payments, the acquirer preferably sends the group of pledges through a card association. The card association is preferably a network, such as VISA® or MasterCard®, that acts as a gateway between the acquirer and the issuer for authorizing and funding transactions. The card association preferably debits the issuers for the payment and credits the acquirer. In effect, the issuers pay the acquirer for the transactions. Once the acquirer has been paid, the system receives payment. The amount the system receives is preferably equal to the pledge amount minus the discount rate, which is the fee the system pays the acquirer for processing the transaction. For example, PayPal typically charges approximately 3% for each transaction. Alternatively, the system may send the authorized pledges to the issuer directly or convert the authorized pledges to payments in any other suitable fashion. All amounts of money pledged and converted into payments are preferably in U.S. Dollars or converted to this by a third party payment processor, such as PayPal or Google Checkout or other banking or credit systems. In this case, the final, settled, transaction amount will preferably be based on the exchange rate in effect on the settlement date.

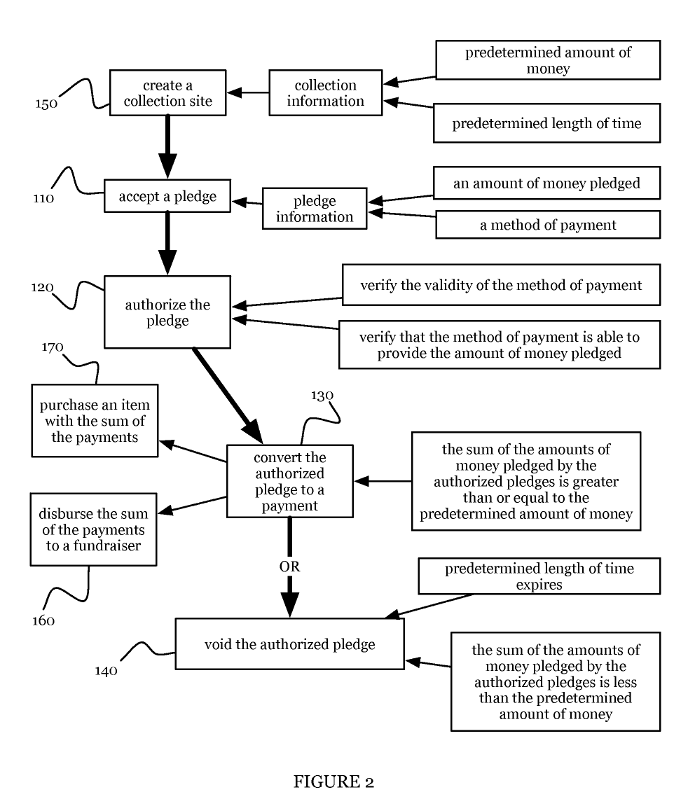

As shown in FIG. 2, the preferred embodiment of the invention further includes Step S140, which recites voiding the authorized pledge and functions to void the pledge (such that it cannot be converted into a payment) upon the expiration of a predetermined length of time, if the sum of the amounts of money pledged by the authorized pledges is less than the predetermined amount of money. In other words, if after the predetermined length of time, the group of contributors fails to reach its goal in pledges (the predetermined amount of money), the system voids all authorized pledges (“payment authorizations” or “authorization holds”). Because the pledge or authorization of the pledge does not constitute a payment or an exchange or transfer of money or resources, if the authorized pledge is voided or deleted, the fundraiser and the contributor do not pay any money (and do not incur the hassle and/or expense of returning or refunding collected funds). In a first variation, voiding the authorized pledge includes “authorization reversal” or “hold invalidation” where the authorization hold is removed and the pledge is voided or deleted from the system.

In addition to voiding the authorized pledge, the system may stop accepting pledges after time expires (S110), stop authorizing pledges (S120), stop converting the authorized pledges to a payment (S130), remove or freeze the collection site, and any suitable combination thereof.

Step S140 furthers the concept of “binary commitment” that preferably reduces or eliminates risk for both the fundraiser and the contributors. “Binary commitment” is the concept that either the group participates as a whole (before the predetermined length of time) or it does nothing, i.e. no one pays until and unless the sum of the amounts of money pledged by the stored or recorded authorized pledges has reached or exceeded the predetermined amount of money and this occurs within the predetermined length of time. Again, this allows contributors to participate in a group purchase or fundraiser without worrying about what other people will do.

The predetermined length of time is preferably set with the predetermined amount of money. The predetermined length of time is preferably greater than 1 day and less than 30 days, but may alternatively be any suitable predetermined length of time. The predetermined length of time is preferably adjustable. In a first variation, if the sum of the amounts of money pledged by the authorized pledges is at least a specified percentage of the predetermined amount of money, the predetermined length of time can be extended. The specified percentage is preferably 90%, but may alternatively be any suitable percentage. The length of time that the predetermined length of time can be any suitable length of time.

As shown in FIG. 2, the preferred embodiment of the invention further includes Step S150, which recites providing a collection site, and functions to provide collection information including a request for the predetermined amount of money, an intended use for the money once collected, a predetermined length of time, and any other suitable information. The collection site is preferably created by a fundraiser. The fundraiser is preferably a person or group of people who wish to collect money or resources from a group of participants. The collection site is preferably an electronic communication or destination such as a website accessed through a network connection (such as an Internet connection), the collection site may alternatively be any other suitable collection engine or location, such as a physical collection site or institution. The collection site preferably notifies all potential contributors of the collection information including what the group plans to do and how much money it needs to collect and/or may notify current contributors. The notification is preferably through emails, postings (on blogs or social networks for example), widgets, online auctions, or any other suitable mode of communication. A collection site is preferably selectively public. A fundraiser may set the collection site to public, or may alternatively hide their collection site from public listings.

The system preferably prompts the fundraiser for the collection information in order to create the collection site. For example, the system may prompt: “What is the title of your collection?”, “What is the minimum you need to collect?” (i.e. what is the predetermined amount of money?), “Describe your collection to your contributors.” (i.e. what is the intended use for the money once collected?), “Tell us how to pay you.”, “Why are you creating a collection?”, “How long will the collection last?” (i.e. what is the predetermined length of time), and any other suitable prompt for any other suitable information. The collection site also preferably includes images or videos, links to external websites, contribution instructions (i.e. how many contributors and how much per contributor), descriptions of contribution benefits, and any other suitable information.

As shown in FIG. 2, the preferred embodiment of the invention further includes Step S160, which recites disbursing the sum of the payments to a fundraiser and functions to send the sum of the payments from the contributors (equal to the sum of the amounts of money pledged minus any transaction or disbursement fees) to the fundraiser. Once the sum of the amounts of money pledged by the stored or recorded authorized pledges is greater than or equal to the predetermined amount of money, and the system has converted the authorized pledges into real payments, the system then disburses the sum of the payments to a fundraiser and/or group leader who preferably makes sure that every contributor receives what they paid for. Fundraisers preferably receive the money or resources that they have successfully collected through an online account such as PayPal or Google Checkout, through a check, or through any other suitable form. If the fundraiser chooses to receive their collected money or resources through a check, the system preferably charges them an additional fee.

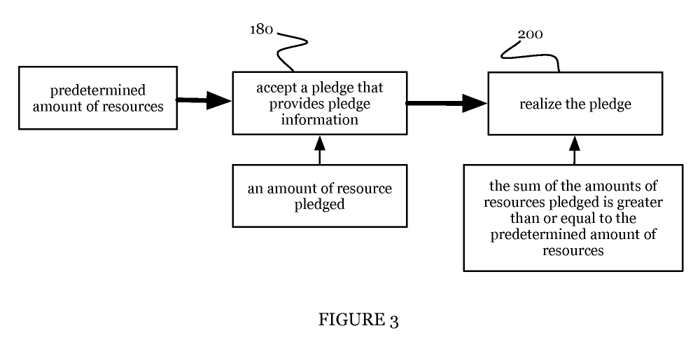

As shown in FIG. 2, the preferred embodiment of the invention may further includes Step S170, which recites purchasing an item with the sum of the payments and functions to purchase an item with the sum of the payments from the contributors (equal to the sum of the amounts of money pledged minus any transaction or disbursement fees). The item would preferably be purchased from an e-commerce or online auction website such as Amazon, eBay, Craigslist, or any other suitable website, company, or institution. The system and method of collecting money or resources from a group of contributors may additionally be utilized for splitting the cost of a large item, buying a product in bulk in order to attain a group discount, raising money for a project, collecting dues, confirming demand for a product that the group leader is selling, pooling money for shared items or gifts, setting up and/or organizing fundraising or volunteering events, raising money for a personal projects, raising an inducement prize, and/or any other suitable event or purpose. As shown in FIGS. 2 and 3, one example for setting up and/or organizing fundraising or volunteering events, a method of collecting resources from a group of contributors includes accepting a pledge from a first contributor S180 and realizing the pledge S200. The pledge provides pledge information including an amount of resources pledged. The pledge is realized when the sum of the amounts of resource pledged is greater than or equal to the amount of resource requested. One example of setting up and/or organizing fundraising or volunteering events and therefore collecting resources from a group of contributors may include a fundraiser or group leader wishing to organize a tree planting event in a local park. The group leader may be only willing to carryout the event if he/she can collect 10 people willing to contribute one hour each of their time. The group leader can use the system to guarantee that each person will actually commit an hour of their time before the group leader and each of the contributors actually commit to the event.

Although omitted for conciseness, the preferred embodiments include every combination and permutation of the various methods, steps, and elements.

As a person skilled in the art will recognize from the previous detailed description and from the figures and claims, modifications and changes can be made to the preferred embodiments of the invention without departing from the scope of this invention defined in the following claims.

We claim:

1. A method of collecting at least a predetermined amount of money from a group of contributors, comprising the steps of:
accepting a pledge from a first contributor that provides pledge information, including an amount of money pledged and a method of payment;
authorizing the pledge by verifying the validity of the method of payment and verifying that the method of payment is able to provide the amount of money pledged; and
converting the authorized pledge to a payment when the sum of the amounts of money pledged by the authorized pledges is greater than or equal to the predetermined amount of money.

2. The method of claim 1 wherein the predetermined amount of money is collected in a predetermined length of time.

3. The method of claim 2 further comprising the step of voiding the pledge upon the expiration of the predetermined length of time, if the sum of the amounts of money pledged by the authorized pledges is less than the predetermined amount of money.

4. The method of claim 2 wherein the predetermined length of time is adjustable.

5. The method of claim 4 wherein the predetermined length of time can be extended when the sum of the amounts of money pledged by the authorized pledges is at least 90% of the predetermined amount of money.

6. The method of claim 2 further comprising at least one of the steps of:
stop accepting pledges upon the expiration of the predetermined length of time, if the sum of the amounts of money pledged by the authorized pledges is less than the predetermined amount of money;
stop authorizing pledges upon the expiration of the predetermined length of time, if the sum of the amounts of money pledged by the authorized pledges is less than the predetermined amount of money; and
stop converting the authorized pledges to a payment upon the expiration of the predetermined length of time, if the sum of the amounts of money pledged by the authorized pledges is less than the predetermined amount of money.

7. The method of claim 1 wherein the method of payment is preferably through a contributor's account selected from the group consisting of credit cards, debit cards, and bank accounts.

8. The method of claim 1 wherein the method of payment is preferably through a contributor's account selected from the group consisting of PayPal and Google Checkout.

9. The method of claim 1 wherein authorizing the pledge is completed without incurring any fees.

10. The method of claim 1 wherein authorizing the pledge includes holding the amount of money pledged as unavailable to the contributor.

11. The method of claim 1 wherein converting the authorized pledge to a payment includes submitting the pledge information to an acquirer.

12. The method of claim 11 wherein converting the authorized pledge to a payment further includes the acquirer authorizing the pledge with an issuer, and then processing the authorized pledge for the contributor.

13. The method of claim 12 wherein the authorized pledge is stored or recorded to be later sent to the acquirer to receive payment.

14. The method of claim 1 wherein converting the authorized pledge to a payment includes transferring the amount of money pledged from the contributor's account to the system.

15. The method of claim 1 wherein converting the authorized pledge to a payment further includes sending the stored or recorded authorized pledges to the acquirer to receive payment.

16. The method of claim 1 further comprising the step of providing a collection site with collection information, including:
a request for the predetermined amount of money in a predetermined amount of time; and
an intended use for the money once collected.

17. The method of claim 16 wherein the collection site is preferably a website accessed through a network connection.

18. The method of claim 17 further comprising the step of notifying a group of contributors of the collection information.

19. The method of claim 1 further comprising the step of disbursing the sum of the payments to a fundraiser.

20. The method of claim 19 wherein disbursing the sum of the payments to a fundraiser includes sending money to the fundraiser through an online account.

21. The method of claim 1 further comprising the step of purchasing an item with the sum of the payments.

22. A method of collecting resources from a group of contributors, the method comprising the steps of:
providing a collection site with collection information, including:
an amount of resource requested; and
an intended use for the resource once collected;
accepting, from a first contributor, a pledge for an amount of resources;
realizing the pledge when the sum of the amounts of resource pledged is greater than or equal to the amount of resource requested.

23. The method of claim 22 wherein the collection information further includes a length of time within which to collect the resources.

24. The method of claim 23 further comprising the step of voiding the pledge upon the expiration of the time within which to collect the resources if the sum of the amounts of resources pledged is less than the amount of resources requested.
